(19) United States
(12) Patent Application Publication
(10) Pub. No.: US 2016/0346738 A1
(43) Pub. Date: Dec. 1, 2016

(54) METHOD AND SYSTEM FOR TREATING FOR PRODUCED WATER

(71) Applicant: New Mexico Technical Research Foundation, Socorro, NM (US)

(72) Inventors: Jianjia Yu, Socorro, NM (US); Robert Balch, Socorro, NM (US); Robert Lee, Socorro, NM (US); Jeff Harvard, Socorro, NM (US); Liangxiong Li, Socorro, NM (US); Daniel Lopez, Socorro, NM (US)

(21) Appl. No.: 14/726,090

(22) Filed: May 29, 2015

(51) Int. Cl. B01D 63/02; C02F 1/40; B01D 61/02; C02F 1/44

(52) U.S. Cl. CPC B01D 63/02; C02F 1/442; C02F 1/40; B01D 61/027; C02F 2101/32

(57) ABSTRACT

A method and system for treating produced water to provide clean water, including passing produced water through at least one super-oleophilic hollow fiber membrane unit of a first stage to remove floating oil and organic matter and provide preliminarily cleaned water, and subsequently passing the preliminarily cleaned produced water through at least one super-hydrophilic nanofiltration hollow fiber membrane unit of a second stage to provide clean water.

The present invention relates to a method and system for treating produced water, especially utilizing hollow fiber membranes.

### BACKGROUND OF THE INVENTION

Produced water is the largest byproduct stream associated with oil and gas production. Oil field-produced water can contain floating oil, particulates and dissolved components such as salt, metal ions and water soluble organics (such as fatty acids and phenols). In addition, produced water normally is very saline, sometimes being nearly six times as salty as sea water, and may contain dissolved hydrocarbons and organic matter. Although the majority of floating oil and organic matter could be simply removed through a centrifuge and/or gravity separation processes, the small particle sizes of the floating oil and/or organic matter in produced water are still a large challenge and the main sources of membrane fouling.

It is therefore an object of the present invention to provide effective treatment of small-sized floating oil droplets and organic matter from produced water.

### BRIEF DESCRIPTION OF THE DRAWINGS

This object, and other objects and advantages of the present invention will appear more clearly from the following specification in conjunction with the accompanying schematic drawings, in which:

FIG. 1 illustrates one exemplary embodiment of Applicant's method and system of treating produced water;

FIG. 2 shows one of the hollow fiber membrane units of Applicant's system;

FIG. 3 is a cross-sectional view through the individual hollow fiber membrane unit of FIG. 2;

FIG. 4 shows a cross-sectional overview of the super-oleophilic fibers of one of the hollow fiber stages in view (a); the outer separation layer of the super-oleophilic fibers of one of the hollow fiber stages in view (b); and the inner supporting layer of the super-oleophilic fiber 21 in view (c);

FIG. 5 shows a cross-sectional overview of the super-hydrophilic fibers of the other hollow fiber stage in view (a); the outer separation layer of the super-hydrophilic fibers of the other hollow fiber stage in view (b); and the inner supporting layer of the super-hydrophilic fiber 22 in view (c); and

FIG. 6 illustrates one exemplary embodiment of a regeneration process for the hollow fiber membrane units of the system of FIG. 1.

### SUMMARY OF THE INVENTION

The method of the present application for treating produced water to provide clean water includes the steps of passing produced water through at least one super-oleophilic hollow fiber membrane unit to remove floating oils and organic matter and

provide preliminarily cleaned produced water; and subsequently passing the preliminarily cleaned produced water through at least one super-hydrophilic nanofiltration hollow fiber membrane unit to provide clean water.

Applicant's system for treating produced water to provide clean water comprises a super-oleophilic hollow fiber membrane stage for receiving produced water for removing floating oil and organic matter from the received produced water to provide preliminarily cleaned produced water; and a super-hydrophilic nanofiltration hollow fiber membrane stage for receiving the preliminarily clean produced water from the super-oleophilic hollow fiber membrane stage to provide clean water.

### DESCRIPTION OF SPECIFIC EMBODIMENTS

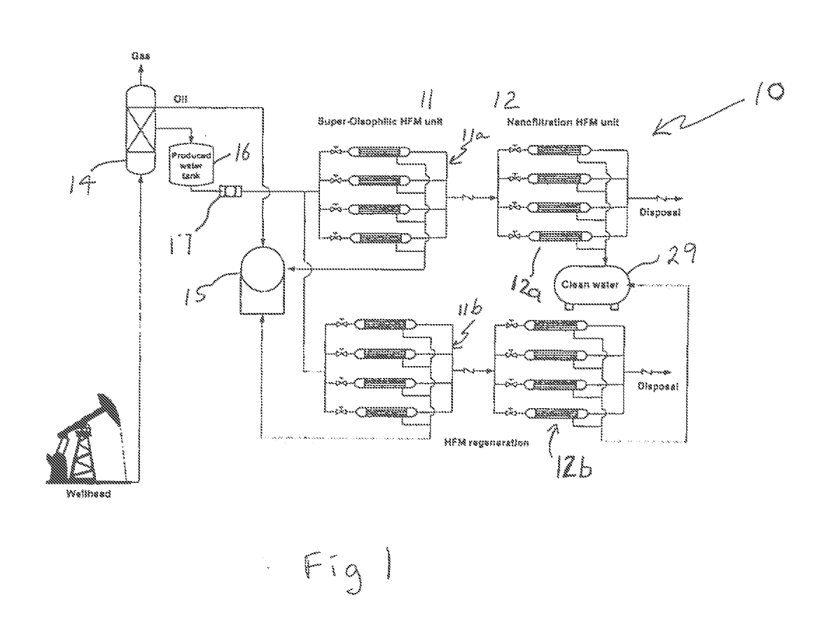

Referring now to the drawings in detail, Applicant's method and system for treating produced water will be described with the aid of FIGS. 1-6, wherein the system illustrated in FIG. 1 is generally designated by the reference numeral 10, and comprises a super-oleophilic hollow fiber membrane stage 11, and a super hydrophilic nanofiltration hollow fiber membrane stage 12.

In the exemplary embodiment illustrated in FIG. 1, produced water, for example from a wellhead, is first conveyed to a separator 14, for example a two or three phase separation system such as a heater/treater, gun-barrel, or other commonly known separator, to separate oil, gas and water along with most solids. The gas is withdrawn from the separator 14 as illustrated, while the oil is withdrawn and conveyed to an oil storage tank 15. The water from which oil and gas have been separated in the separator 14, and which still contains tiny floating droplets of oil and organic matter, is then conveyed either directly to the super-oleophilic hollow fiber membrane stage 11 of the system 10 or, in the illustrated embodiment, is conveyed first to the produced water tank 16. From there, the preliminarily treated produced water is conveyed to the stage 11 of the system 10, for example passing first through the filter 17, where some of the remaining organic matter is removed.

In the illustrated embodiment, the super-oleophilic hollow fiber membrane stage 11 is comprised of two portions 11a and 11b, each of which comprises several individual hollow fiber membrane units, with the two portions 11a and 11b of the stage 11 making continuous operation of the system 10 possible, as will be described in detail subsequently. Similarly, the super-hydrophilic nanofiltration hollow fiber membrane stage 12 is comprised of two portions 12a and 12b. Thus, the produced water is conveyed through the system 10, where the super-oleophilic hollow fiber membrane units 19 of the stage 11 filter out the remaining oil and organic matter to the oil storage tank 15, with the thus cleaned produced water then flowing through nanofilitration hollow fiber membrane units 19 of the stage 12, where the contaminates of multivalent ions, bacteria and small suspended solids are rejected through the inside of the hollow fiber membrane units, with the clean water that has been thus processed being conveyed out through the hollow fiber membrane walls.

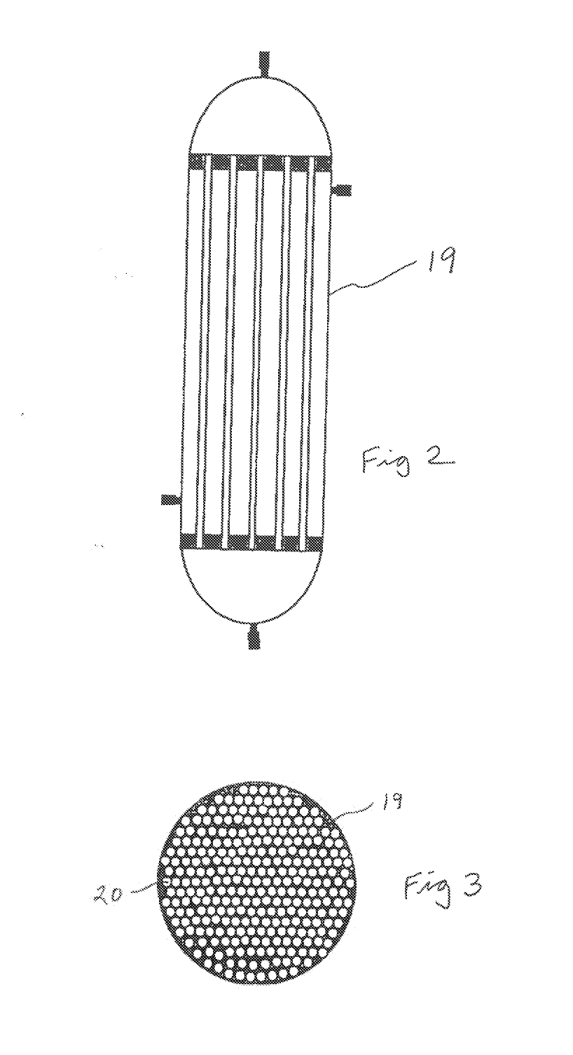

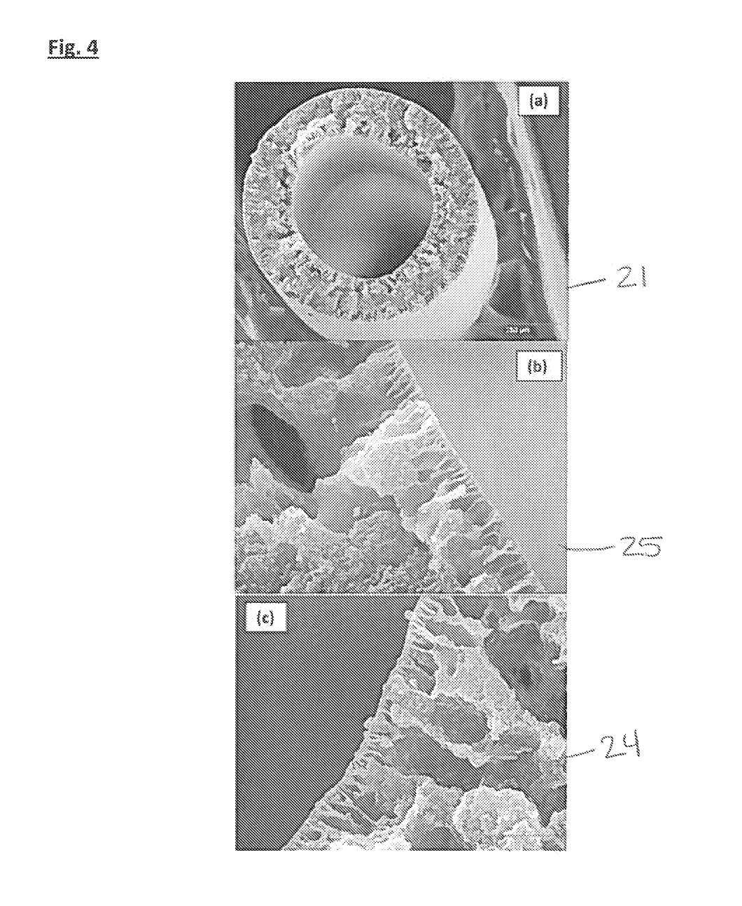

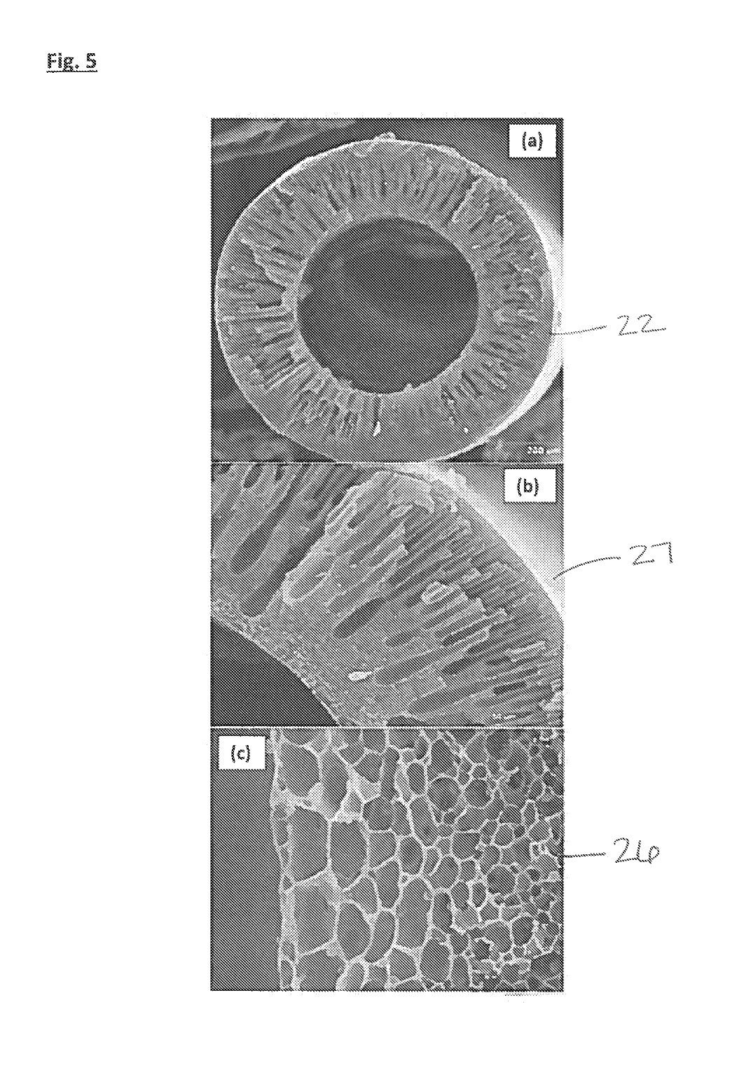

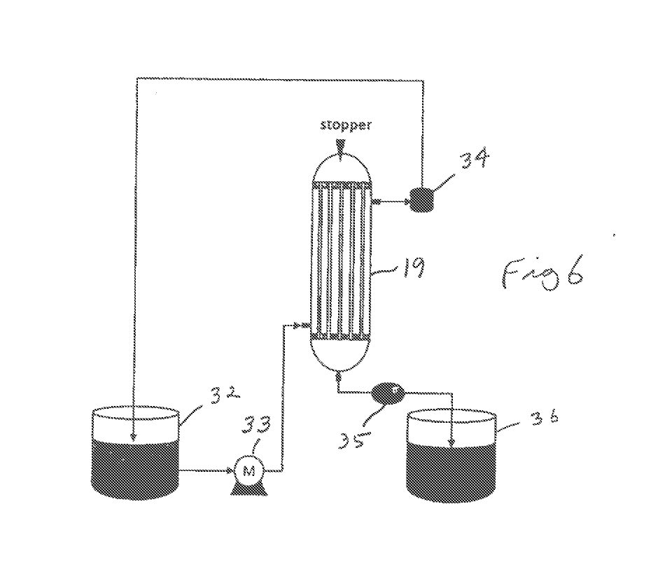

An individual hollow fiber membrane unit 19 of the stage 11 or the stage 12 is shown in FIG. 2, with a cross-section through the unit 19 being shown in FIG. 3, which diagramically illustrates the hollow fibers 20 of the unit 19. These hollow fibers include the super-oleophilic fibers 21 of the stage 11, and the super-hydrophilic fibers 22 of the stage 12, with details of the super-oleophilic fibers 21 and of the super-hydrophilic fibers 22 being illustrated in FIGS. 4 and 5 respectively, where the microcellular and sponge-like structure of the super-oleophilic fibers 21, and the finger-like and sponge-like structure of the super-hydrophilic fibers 22, can be clearly seen. In particular, FIG. 4 shows a cross-sectional overview in view (a), the outer separation layer in view (b), and the inner supporting layer of the super-oleophilic fiber 21 in view (c); similarly, FIG. 5 shows in view (a) a cross-sectional overview, the outer separation layer in view (b), and the inner supporting layer of the super-hydrophilic fiber 22 in view (c).

In the super-oleophilic hollow fiber membrane stage 11 for the removal of oil and organic contaminate, the preferably asymmetric hollow fibers 21 are basically composed of two main components, namely an inner supporting layer 24 (see FIG. 4c), and an outer separation layer 25 (see FIG. 4b). The material for the inner layer 24 is chosen from conventional polymers, whereby the function of the porous inner layer 24 is to provide mechanical support for the outer layer 25. The inner layer 24 preferably has a high surface porosity with interpenetrated bulk porosity, so that there is minimal resistance to the transport of water through the inner layer 24. The outer layer 25 is made from a high performance polymer, which has a high separation efficiency. Although the outer layer is very thin (5-20 μm) its structure may still be asymmetric. The super-thin outer separation layer 25 of the hollow fiber 20 significantly reduces membrane costs.

The super-hydrophilic nanofiltration hollow fiber membrane stage 12 is comprised of antifouling nanofiltration hollow fiber membrane units to remove dissolved solids and produce high-quality clean water. Nanofiltration is a pressure-driven separation process employing a semi-permeable membrane with separation characteristics in the intermediate range between reverse osmosis and ultra-filtration; hence, higher permeate quality and solvent permeability can be obtained with nanofiltration as compared to ultrafiltration and reverse osmosis. Nanofiltration is an effective means for the removal of multivalent ions, bacteria, and small suspended solids from produced water. Applicant's super-hydrophilic hollow-fibers 22 have many advantages over membranes in a flat sheet configuration, such as high surface to volume ratio, as well as no requirement for feed and permeate spacers as well as less need for pretreatment and maintenance. The fibers 22 are comprised of an inner supporting layer 26 (FIG. 5c) and an outer separation layer 27 (FIG. 5b).

As can be seen in FIG. 1, after the water has passed through the super-hydrophilic fibers 22 of the hollow fiber membrane stage 12, the clean water that has been produced is collected in a tank 29. The material removed from the water is transported away for disposal, as illustrated.

To allow for continuous operation of the system 10, both of the hollow fiber membrane stages 11 and 12 are provided with two portions, namely the portions 11a, 11b and 12a and 12b respectively. Thus, to be able to regenerate some of the individual hollow fiber membrane units 19 while the system 10 continues to operate, either the portions 11a and 12a, or 11b and 12b, are able to be switched into or out of operation, for example via the individual valves 30 or a common valve for each portion 11a, 12a and 11b, 12b. In the illustrated embodiment, each portion of the stages 11 and 12 comprises four individual hollow fiber membrane units 19.

FIG. 6 illustrates one exemplary regeneration process for the portions 11a, 12a, and 11b, 12b, which portions could even be physically removed from the system 10 for the regeneration process. As shown, clean water from the tank 32 is conveyed via the pump 33 to the shell side of the hollow fibers 20 in a hollow fiber membrane unit 19, with the penetrated water being received at, and removed from, the lumen side of the hollow fibers 20. In one exemplary embodiment, the operation pressure for back flushing regeneration is proposed to be 30 psi, and can be controlled with a back pressure regulator 34. The penetrated water can be monitored with a conductivity meter 35. A further tank 36 can be provided for water that penetrates through some of the membranes. The withdrawn penetrated water can be returned to the tank 32, for example after appropriate filtration and the like, and/or fresh water can be added to the tank 32.

Examples of suitable materials for use in the components in the system 10 include Kynar® PVDF for the super-oleophilic hollow fiber membranes and Solvay® PES for the super-hydrophilic hollow fiber membranes.

Exemplary dimensions for the super-oleophilic hollow fibers 21 of the hollow fiber membranes are in a range from 385 μm to 2000 μm, and also for the super-hydrophilic fibers of the hollow fiber membranes are in the range from 385 μm to 2000 μm, while exemplary dimensions for each individual hollow fiber membrane unit are in the range of from 2 to 6 inches diameter, and 1-4 feet in length.

The present invention is, of course, in no way restricted to the specific disclosure of the specification and drawings, but also encompasses any modifications within the scope of the appended claims.

1. A method of treating produced water to provide clean water, including the steps of:
passing produced water through at least one super-oleophilc hollow fiber membrane unit to remove floating oil and organic matter and provide preliminarily cleaned produced water; and
subsequently passing the preliminarily cleaned produced water through at least one super-hydrophilic nanofiltration hollow fiber membrane unit to provide clean water.

2. The method of claim 1, wherein prior to passing produced water through at least one super-oleophilic hollow fiber membrane unit, pretreating the produced water to remove some oil and organic matter.

3. The method of claim 2, wherein the pretreating step comprises passing the produced water through a separator for separating out gas and oil from the water.

4. The method of claim 1, wherein each of said super-oleophilic hollow fiber membrane units comprises a plurality of super-oleophilic fibers, and wherein each super-hydrophilic nanofiltration hollow fiber membrane unit comprises a plurality of super-hydrophilic fibers.

5. The method of claim 4, wherein the super-oleophilic hollow fiber membrane units form a first stage comprised of two portions, each of which is comprised of at least one individual hollow fiber membrane unit, and wherein the super-hydrophilic nanofiltration hollow fiber membrane units form a second stage, each of which is comprised of at least one individual hollow fiber membrane unit.

6. The method of claim 5, which includes a further step of regenerating one of the portions of the super-oleophilic hollow fiber membrane stage and one of the portions of the super-hydrophilic nanofiltration hollow fiber membrane stage while continuing to operate the remaining portions of the super-oleophilic and super-hydrophilic hollow fiber membrane stages.

7. The method of claim 6, wherein the regeneration step comprises passing water under pressure through the hollow fibers of the hollow fiber membrane units.

8. A system for treating produced water to provide clean water, comprising;
a super-oleophilic hollow fiber membrane stage for receiving produced water for removing floating oil and organic matter from the received produced water to provide preliminarily cleaned produced water; and
a super-hydrophilic nanofiltration hollow fiber membrane stage for receiving the preliminarily cleaned produced water from the super-oleophilic membrane stage to provide clean water.

9. The system of claim 8, which further includes means to pretreat produced water prior to conveyance of the water to the super-oleophilic hollow fiber membrane stage.

10. The system of claim 9, wherein the means to pretreat comprises a separator for separating out gas and oil from the produced water.

11. The system of claim 8, wherein the super-oleophilic hollow fiber membrane stage comprises at least one individual super-oleophilic hollow fiber membrane unit and wherein the super-hydrophilic nanofiltration hollow fiber membrane stage comprises at least one individual super-hydrophilic nanofiltration hollow fiber membrane unit.

12. The system of claim 11, wherein each super-oleophilic hollow fiber membrane unit comprises a plurality of super-oleophilic fibers, and wherein each super-hydrophilic nanofiltration hollow fiber membrane unit comprises a plurality of super-hydrophilic fibers.

13. The system of claim 12, wherein the super-oleophilic hollow fiber membrane stage comprises two portions, each of which is comprised of at least one individual super-oleophilic hollow fiber membrane unit, and wherein the super-hydrophilic nanofiltration hollow fiber membrane stage is comprised of two portions, each of which is comprised of at least one super-hydrophilic nanofiltration hollow fiber membrane unit.

14. The system of claim 13, which further includes means for switching one of the portions of the super-oleophilic hollow fiber membrane stage and one of the portions of the super-hydrophilic nanofiltration hollow fiber membrane stage out of operation.

15. The system of claim 14, which further includes means for conveying water under pressure through the switched-out ones of the portions of the super-oleophilic and super-hydrophilic hollow fiber membrane stages to regenerate the units of such portions.
